(19) United States
(12) Patent Application Publication
(10) Pub. No.: US 2026/0038039 A1
(43) Pub. Date: Feb. 5, 2026

(54) MACHINE LEARNING BASED VEHICLE TITLE VALIDATION

(71) Applicant: Yendo Inc., Dallas, TX (US)

(72) Inventors: Jordan Miller, Dallas, TX (US); Aaron Sengstacken, Westwood Hills, KS (US)

(21) Appl. No.: 19/285,771

(22) Filed: Jul. 30, 2025

Related U.S. Application Data
(60) Provisional application No. 63/677,960, filed on Jul. 31, 2024.

(51) Int. Cl. G06Q 40/03; G06V 10/774; G06V 10/776; G06V 10/94; G06V 30/19

(52) U.S. Cl. CPC G06Q 40/038; G06V 10/774; G06V 10/776; G06V 10/945; G06V 30/19147; G06V 30/1916

(57) ABSTRACT

A computer-implemented method and system for extracting and validating structured vehicle title data using a machine-learned pipeline. A user interface on a client device enables users to upload an image of a physical vehicle title. An optical character recognition (OCR) module extracts text from the image, and a preprocessing engine constructs a multi-modal input tensor comprising the image, OCR output, and schema-based structured data templates. The tensor is input to a machine-learned model that outputs a structured data object including vehicle, title, and ownership information. A validation module cross-references this output with external title records to generate validation metadata. Based on the validation, the system performs actions such as lien registration or issuing user notifications. The model may be trained using multi-modal training data including annotated title images and structured templates. The structured data output and validation results are encoded in a machine-readable format for downstream use.

### CROSS-REFERENCE TO RELATED APPLICATION

This application claims the benefit of U.S. Provisional Application Ser. No. 63/677,960, filed Jul. 31, 2024, the entire content of which is incorporated by reference herein.

### TECHNICAL FIELD

The present disclosure relates generally to image processing and structured data extraction, and more particularly to systems and methods for extracting, validating, and processing vehicle title information using machine learning and external data sources.

### BACKGROUND

In the realm of online financial services, the process of securing loans against property (e.g., personal property such as vehicles) has traditionally been a complex and time-consuming endeavor. Borrowers have typically been required to provide physical copies of titles, ownership documents, and other relevant information to lenders for manual verification and lien placement. This manual process introduces delays, increases operational costs for lenders, and creates inconvenience for borrowers who may need to physically visit lending institutions or submit documents through mail. Furthermore, the manual verification and lien placement process is prone to errors and inconsistencies, as human operators may misinterpret information on vehicle titles or make mistakes during data entry. The manual verification and validation process also does not scale effectively in the context of an online system, which may be operating continuously at all times and required to process a large volume of transactions in real-time.

### SUMMARY

In one or more embodiments, a computer-implemented method is provided for extracting and validating structured vehicle title data. A user interface is presented on a client device to enable a user to upload an image of a physical vehicle title document. The image is processed using optical character recognition (OCR) to extract text, and a multi-modal input—including the image, OCR output, and structured data templates—is generated and provided to a machine-learned model. The model outputs structured data identifying title, vehicle, and ownership information, which is validated against reference metadata retrieved from external title databases. Based on the validation results, the system may take actions such as placing a lien, notifying the user, or issuing an error. Additional embodiments include model training on multi-modal inputs, inclusion of validation metadata in the structured output, and encoding the output in machine-readable key-value format.

### BRIEF DESCRIPTION OF THE DRAWINGS

FIG. 1A illustrates an example system environment for an online system, in accordance with one or more embodiments.

FIG. 1B is a block diagram of an online system, in accordance with one or more embodiments.

FIG. 2A illustrates a process for obtaining a structured data object as an output from a machine learning-based pipeline of an online system, in accordance with one or more embodiments.

FIG. 2B shows an example of a structured data template input to a machine learning-based pipeline of an online system, in accordance with one or more embodiments.

FIG. 2C shows an example of a structured data object output from a machine learning-based pipeline of an online system, in accordance with one or more embodiments.

FIGS. 3A-3M are example illustrations of graphical user interfaces (GUIs) provided by the online system to user devices for automatically extracting and validating structured vehicle title data, in accordance with one or more embodiments.

FIG. 4 is a flowchart for a method of automatically extracting and validating structured vehicle title data, in accordance with one or more embodiments.

FIG. 5 is a block diagram illustrating components of an example machine for reading and executing instructions from a machine-readable medium, in accordance with one or more example embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated may be employed without departing from the principles described herein.

### Configuration Overview

There has been a growing demand for online platforms that can streamline the process of securing loans against vehicle assets or otherwise validate vehicle ownership for other use cases. Such platforms may aim to provide borrowers with a convenient and efficient way to access credit while enabling lenders to assess vehicle ownership information and establish liens with greater speed and reliability. However, conventional systems often rely on manual data entry or limited OCR capabilities, which are error-prone and ill-suited for large-scale, real-time processing of unstructured title documents.

To address these challenges, the present disclosure provides a computer-implemented system and method that automates extraction, validation, and processing of vehicle title data. The system may receive a digital image of a physical vehicle title document, such as a certificate of title, captured by a user device. An OCR module may extract text from the image, and a preprocessing engine may construct a multi-modal input tensor that includes the image, the extracted text, and structured data templates. The structured data templates may define expected field formats for key information typically found in vehicle title documents, such as the layout, data types, and value constraints for fields like vehicle identification number (VIN), owner name, issue date, and title number. These templates may guide a machine-learned model by providing a reference schema to help ensure consistent and accurate extraction of structured data from unstructured document images.

In some embodiments, the online system may provide the multi-modal input tensor to a machine-learned model, such as a transformer-based neural network trained on labeled title documents, to generate a structured data object containing relevant vehicle, title, and ownership information. Examples of extracted information may include the vehicle identification number (VIN), make, model, odometer reading, ownership classification, issuing authority, and title remarks.

The system may also retrieve authoritative vehicle title metadata from external systems (e.g., Department of Motor Vehicles (DMV) databases or national title registries) by, e.g., making calls to application programming interfaces (APIs) that may be exposed by such external databases for data access. This data may be extracted from the external database system based on information input by the user to the online system (e.g., VIN, license plate, owner name and address, and the like). The data may be used as ground truth based on which the system may perform data validation for the input (e.g., image of the title document) received from the user.

A validation module of the online system may compare the structured data extracted from the image captured and input by the user with this reference (ground truth) metadata from the external database using a set of predefined validation rules, such as verifying title recency, matching ownership, or checking for existing liens. The validated structured data object may then be updated to include field-level validation results in a machine-readable format.

Based on the validation outcome, the system may automatically perform downstream actions, such as initiating a lien placement by transmitting a lien registration request to an external title management system, or notifying the user of a validation failure (including information on how to rectify the failure). Upon successful validation, the system may deem the vehicle eligible for lien placement and proceed with a credit transaction, allowing the user to obtain credit in exchange for a lien on the vehicle. The system may thus provide a scalable and technically robust solution to the problem of real-time, accurate interpretation and validation of unstructured vehicle title documents-enabling secure, automated transaction processing in the digital lending space.

### Example System Environment

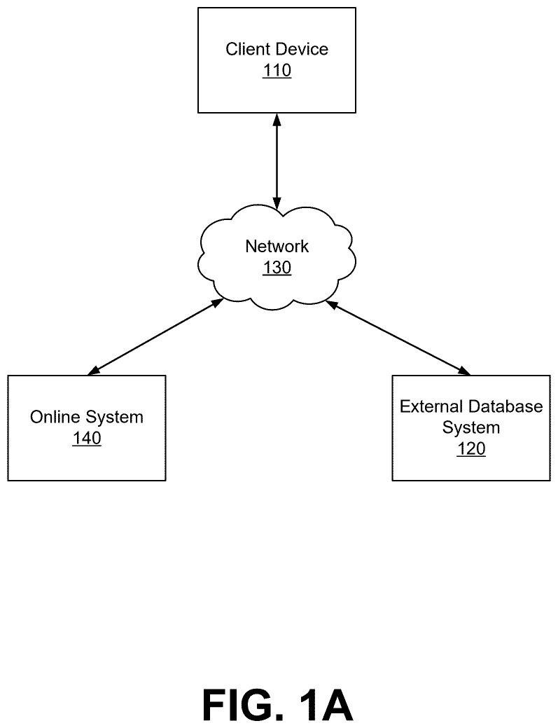

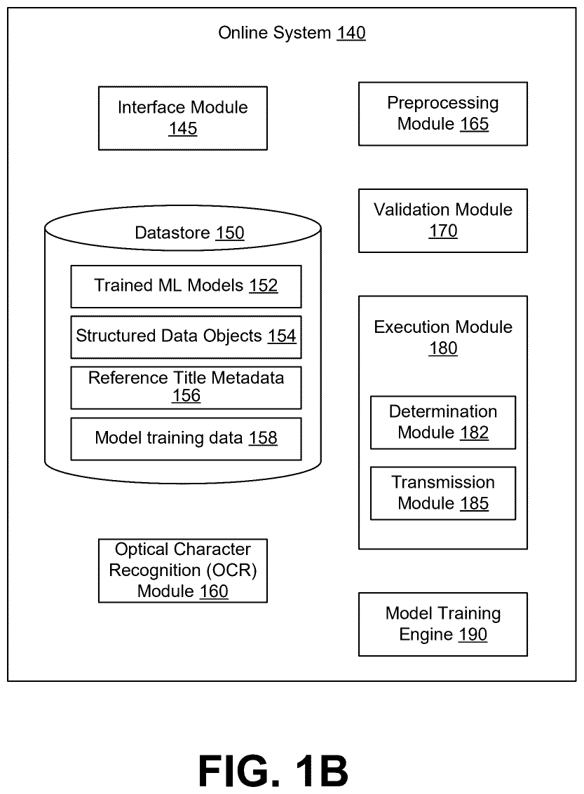

FIG. 1A illustrates an example system environment for an online system 140, in accordance with one or more embodiments. The system environment illustrated in FIG. 1A includes a client device 110, an external database system 120, network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention. While one client device 110 and one external database system 120 are illustrated in FIG. 1A, any number of client devices and external databases may interact with the online system 140. As such, there may be more than one client devices 110 or external database systems 120.

The client device 110 is a client device through which a customer may interact with the online system 140. The client device 110 can be a personal or mobile computing device, such as a smartphone, a tablet, a laptop computer, or desktop computer. In some embodiments, the customer client device 110 executes a client application that uses an application programming interface (API) to communicate with the online system 140. In some embodiments, the client device 110 may be a smartphone with an in-built camera.

In some embodiments, a customer uses the client device 110 to perform a financial transaction with the online system 140. For example, the customer may be the owner of a piece of property (e.g., real property, personal property such as a vehicle), and the financial transaction may involve the customer obtaining credit from the online system 140 in exchange of a lien on the vehicle. As another example, the financial transaction may involve the customer selling their property to an entity associated with the online system 140 in exchange of a payment or other form of consideration. As used herein, a “vehicle” can be any type of vehicle that can be used for transporting people or goods such as a passenger car, a commercial vehicle such as a truck or semi-trailer, a boat, a recreational vehicle, a motorcycle, an airplane, and the like. As used herein, “property” with respect to which the customer may enter into a financial transaction as described herein can include real property such as a house or other immovable asset, personal property such as a vehicle, a painting, a collectible item, or any other movable good that holds value.

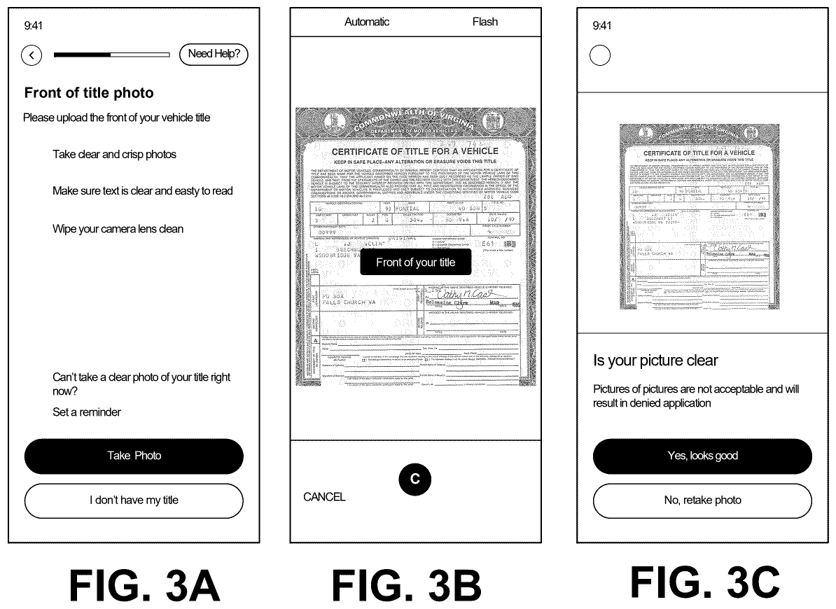

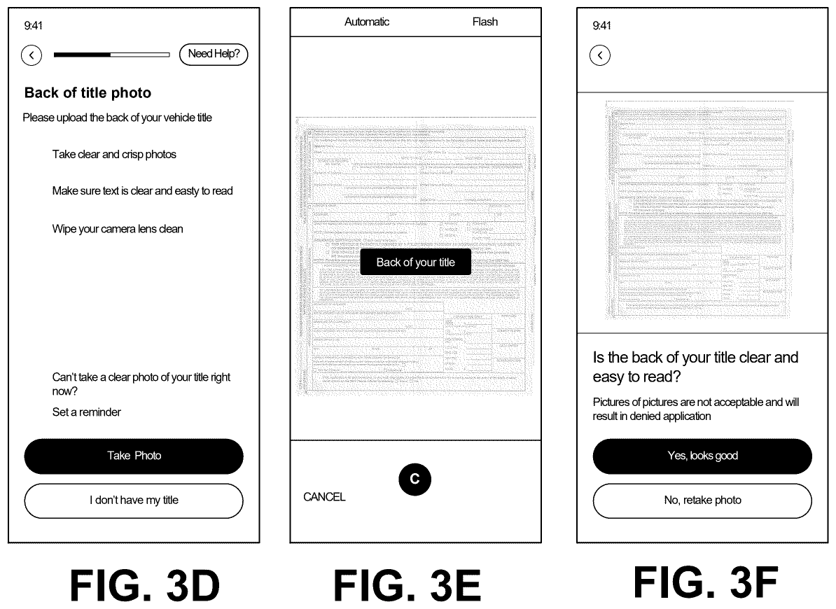

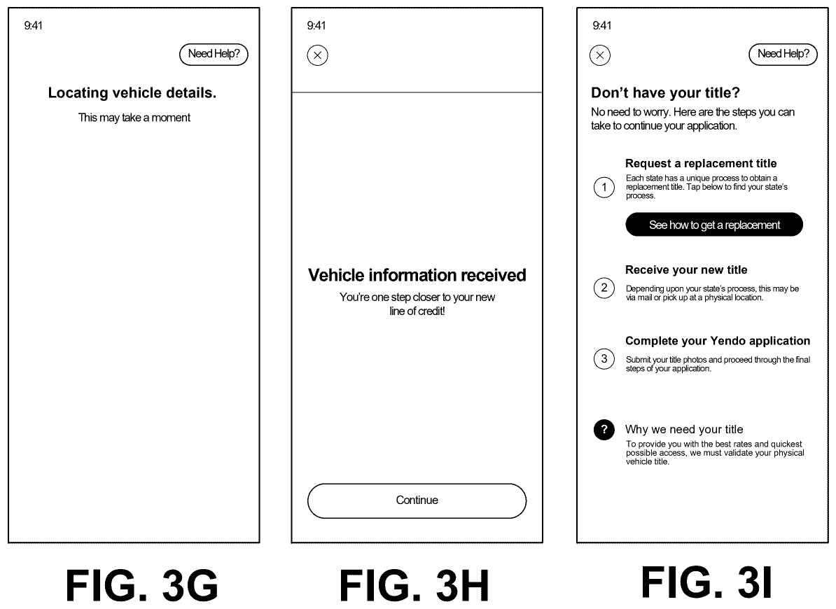

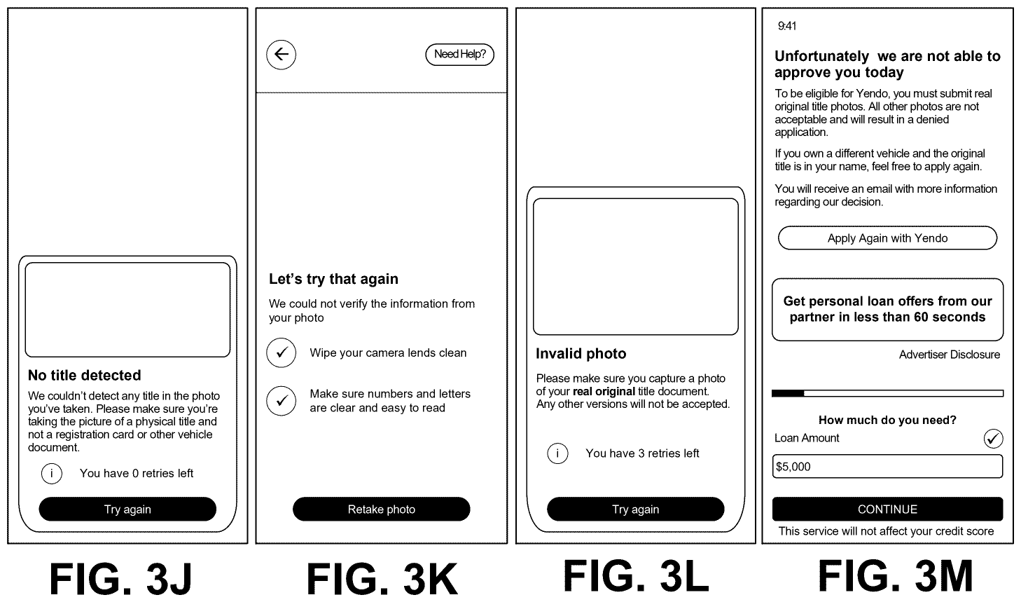

The client device 110 presents an interface to the customer. The interface is a user interface that the customer can use to interact with the online system 140. The interface may be part of an application operating on the client device 110 (e.g., application deployed by the online system 140). The interface (e.g., FIGS. 3A-3M) may allow the customer to, e.g., select a financial product such as a credit card, start a new application, input information associated with a vehicle, and the like. In this context, the information associated with the vehicle may include photos or videos of the vehicle, photos or videos of vehicle ownership information associated with the vehicle, identification information of the customer, identification information associated with the vehicle.

Vehicle ownership information may be any automotive document associated with ownership and transfer of ownership of the vehicle. For example, the vehicle ownership information may include the certificate of title, title transfer document, power of attorney statement, lien certificate, and the like. The photo or video of the vehicle ownership document may be a live photo or video captured in real-time using a camera of the client device 110. The identification information of the customer may include customer name, address, phone number, social security number, and the like. The identification information associated with the vehicle may include the license plate number, vehicle identification number (VIN), make, model, color, year, and current odometer reading.

The external database system 120 may be a state, federal, or other privately owned and operated record (e.g., National Motor Vehicle Title Information System (NMVTIS), state DMV) that allows the online system 140 to instantly and reliably verify the information on a paper title against the electronic data from the state that issued the title. The external database 120 may protect consumers or the online system 140 from fraud and unsafe vehicles and prevents the resale of stolen vehicles. In one or more embodiments, the external database system 120 may expose one or more application programming interfaces (APIs), and the online system 140 may make an API call to the external database system 120 and include identification information of a vehicle (e.g., VIN, license plate, identification information of current owner). The API of the external database system 120 may return a larger array of data points (e.g., current title information including title date, historical title information, vehicle information, ownership information) to the online system 140. In one or more embodiments, the data received from the external database system 120 may be used as ground truth when validating the information (e.g., via textual entry into a form, via an image of a title document) supplied by a customer via the client device 110 to the online system 140. In some embodiments, the external database system 120 may also expose APIs that may allow the online system 140 to update information associated with a particular VIN. For example, the online system 140 may call an API of the system 120 to transmit a request to place a lien on a vehicle and provide associated information (e.g., a document signed by the owner of the vehicle, information relating to the lien holder, etc.) to the system 120.

The client device 110, the external database system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 may enable customers to enter into financial transactions based on their ownership interest in items of personal or real property, such as vehicles. In some embodiments, the online system 140 may validate ownership information and provide the validation as an online service to third parties. In the realm of vehicle lien backed credit, the online system 140 may allow a user of the client device 110 to submit an application (e.g., application for a credit card, loan, or for selling the property). As part of the application, the user may submit one or more images of documents indicating vehicle ownership such as the current certificate of title of the vehicle, one or more images of their ID (e.g., driver's license, passport), and fill out a form including identification information of the user and of the vehicle. Based on the submitted information (e.g., in form fields, captured and uploaded images), the online system 140 may perform a series of validation checks based on a predetermined set of rules and utilizing external data sources as ground truth and return a result of the validation as a structured data object. The online system 140 may further automatically take actions based on a result of the validation (e.g., approve the credit application, issue credit to the user in the form of a credit card with preloaded balance, place a lien on the vehicle, execute a workflow to obtain consent of a vehicle co-owner prior to placing the lien on the vehicle, and the like). Examples of components and functionalities of the online system 140 are discussed in detail below with reference to FIG. 1B.

### Example Online System

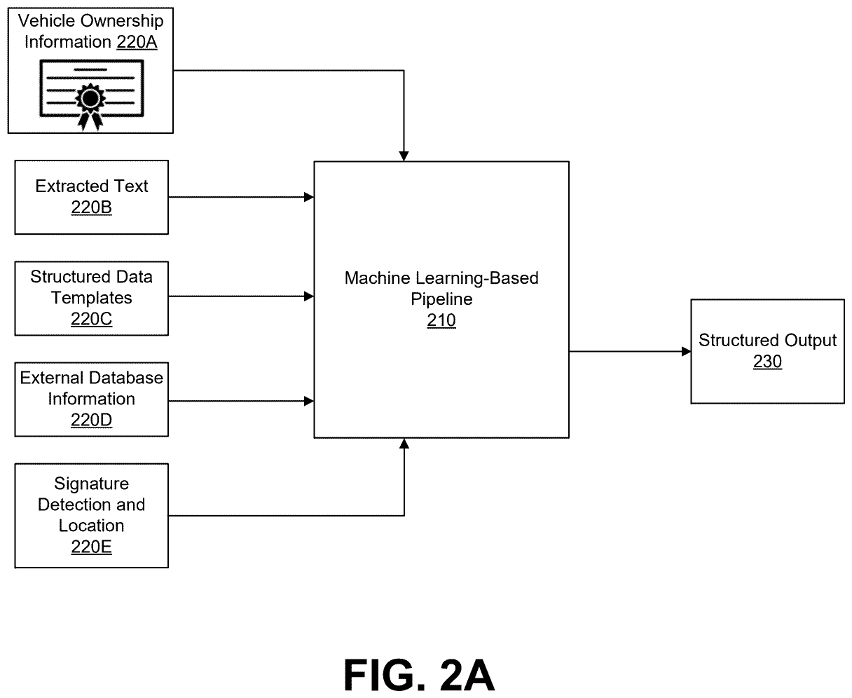

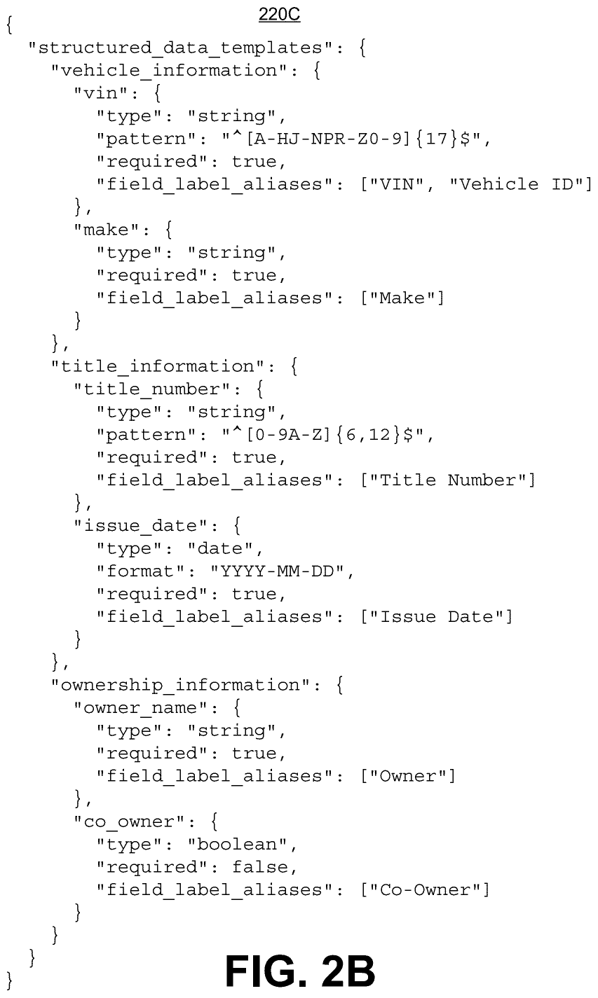

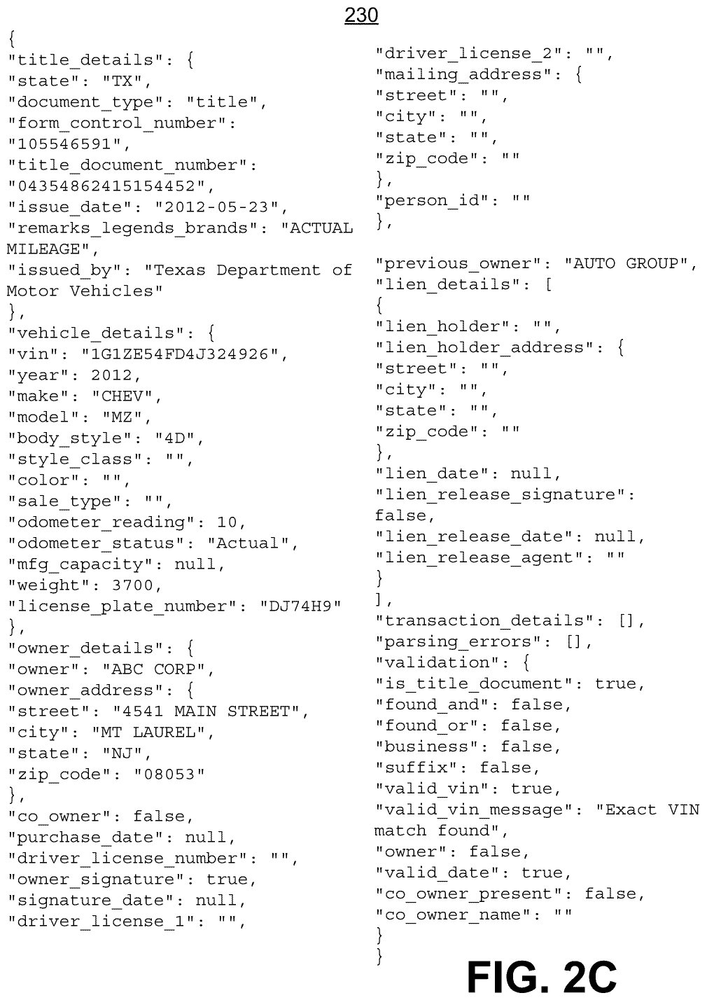

FIG. 1B is a block diagram illustrating various components of an example online system 140, in accordance with one or more embodiments. The online system 140 may include an interface module 145, a datastore 150, an optical character recognition (OCR) module 160, a preprocessing module 165, a validation module 170, an execution module 180, and a model training engine 190. The datastore 150 may store different types of data utilized, generated, or received by the online system 140 for performing the automated extraction, validation, and vehicle title data processing operations described herein. For example, the datastore 150 may store trained machine-learned (ML) models 152 for extracting vehicle information, ownership information, and title information from images of vehicle title documents. The datastore 150 may also store structured data objects 154 output by the ML models 152 and further updated by the validation module 170 (see FIG. 2B). The datastore 150 may further store reference title metadata 156 which may be received from external database systems (e.g., DMV databases, national motor vehicle title information system (NMVTIS) databases, and the like) which serve as ground truth against which the user submitted data is validated. Still further, the datastore 150 may store model training data 158 including tagged and labeled title document images which are used to train the ML models 152. The execution module 180 may include a determination module 182 and a transmission module 185. In some embodiments, the online system 140 may include fewer or additional components. The online system 140 also may include different components. The functions of various components in the online system 140 may be distributed in a different manner than described below.

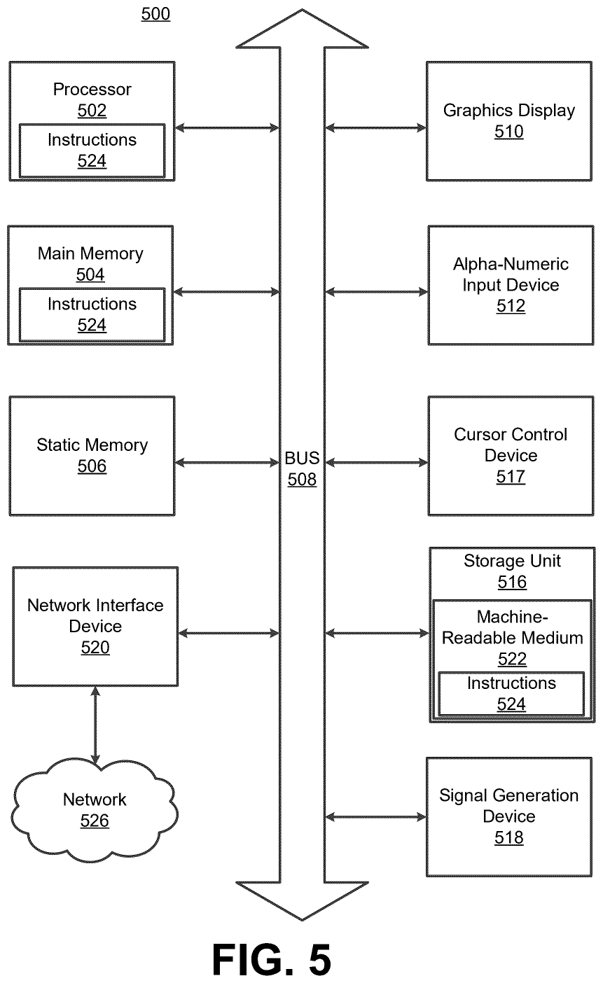

The components of the online system 140 may be embodied as software engines that include code (e.g., program code comprised of instructions, machine code, etc.) that is stored on an electronic medium (e.g., memory and/or disk) and executable by a processing system (e.g., one or more processors and/or controllers). The components also could be embodied in hardware, e.g., field-programmable gate arrays (FPGAs) and/or application-specific integrated circuits (ASICs), that may include circuits alone or circuits in combination with firmware and/or software. Each component in FIG. 1B may be a combination of software code instructions and hardware such as one or more processors that execute the code instructions to perform various processes. Each component in FIG. 1B may include all or part of the example structure and configuration of the computing machine described in FIG. 5.

The interface module 145 may facilitate user interaction with the online system 140 through a graphical user interface (GUI) presented on a client device 110. In some embodiments, the interface module 145 may be implemented as a mobile application developed and deployed by the online system 140 and made available for download via application distribution platforms such as the Apple App Store (for iOS devices) and Google Play Store (for Android devices). The mobile application may execute on the client device 110 and provide a native GUI for capturing and transmitting images, completing application forms, and receiving status updates from the online system 140. In other embodiments, the interface module 145 may be implemented as a web-based application accessible through a browser on the client device 110, or as part of a software-as-a-service (SaaS) platform accessed over a network (e.g., network 130 of FIG. 1A). The interface module 145 may communicate with other components of the online system 140 using application programming interfaces (APIs), which may include RESTful endpoints, webhooks, or other communication mechanisms. Example GUIs generated by the interface module 145 are illustrated in FIGS. 3A-3M and described in further detail below.

One or more of the machine-learned models 152 may be language models in which the sequence of input tokens or output tokens are arranged as a tensor with one or more dimensions, for example, one dimension, two dimensions, or three dimensions. In one or more embodiments, the language models are large language models (LLMs) that are trained on a large corpus of training data to generate outputs for the NLP tasks. An LLM may be trained on massive amounts of text data, often involving billions of words or text units. Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one or more embodiments, the ML models 152 may include neural networks (e.g., transformer-based neural networks), deep neural networks, convolutional neural networks, transformer neural networks, fuzzy rule matching, and the like.

In one instance, one or more of the ML models 152 may be trained and deployed or hosted on a cloud infrastructure service. The machine-learned models 152 may be pre-trained by the online system 140 using the model training engine 190 and the model training data 158, or the model training may be handled by one or more entities external to the online system 140. The models 152 may be trained on a large amount of data from various data sources. For example, the data sources include websites, articles, posts on the web, and the like. From this massive amount of data coupled with the computing power of the machine-learned model, the model is able to perform various tasks and synthesize and formulate output responses based on information extracted from the training data. Additional details regarding the ML models 152 their training is described below in connection with FIG. 2A.

The optical character recognition (OCR) module 160 may perform automated text extraction from images of physical vehicle title documents received via the client device 110. The OCR module 160 may implement one or more machine-learned or rule-based OCR engines to detect, segment, and recognize alphanumeric characters and symbols embedded within captured images of documents, including low-resolution, skewed, or partially obstructed inputs. In some embodiments, the OCR module 160 may include preprocessing routines such as image binarization, deskewing, denoising, contrast normalization, and layout analysis to enhance recognition accuracy. The OCR module 160 may output a machine-readable text representation of the content extracted from the input image (e.g., raw OCR text), along with positional metadata (e.g., bounding box coordinates) for each recognized token or text segment. This OCR output may be encoded using a structured format such as JSON or XML and provided as input to downstream components such as the preprocessing module 165 and the machine-learned models 152 for structured data extraction. In some embodiments, the OCR module 160 may support multiple languages or document formats based on the jurisdiction or issuing authority of the vehicle title.

The preprocessing module 165 may receive the raw OCR output from the OCR module 160 and performs multi-modal input construction to prepare the data for structured inference by the machine-learned models 152. In some embodiments, the preprocessing module 165 may generate a multi-modal input tensor that combines the OCR output, the original input image, and one or more structured data templates. These templates may define expected field formats, spatial layouts, regular expressions, value types (e.g., numeric, alphanumeric, date), and semantic constraints for key data elements commonly present on vehicle title documents (e.g., VIN, owner name, issue date, issuing authority, odometer reading). The preprocessing module 165 may also normalize and tokenize the OCR output, align the text with predefined regions of interest (ROIs) based on positional metadata, and encode the resulting features into a format suitable for model inference. The combined multi-modal tensor may serve as a unified representation of visual and textual features that can be transmitted to one or more machine-learned models 152 of a ML based pipeline for automated data extraction, validation and processing.

The validation module 170 may be configured to perform automated consistency and accuracy checks on the structured data object output by the ML models 152. Upon receiving the structured output (e.g., title information, ownership data, and vehicle metadata), the validation module 170 may retrieve reference title metadata 156 from one or more external database systems 120 (e.g., DMV databases, NMVTIS) via, e.g., API-based queries. The validation module 170 may then apply a predefined set of logic rules and validation constraints to compare each extracted field with its corresponding reference value. For example, the validation module 170 may check whether the extracted VIN matches the registered VIN in the reference metadata, whether the title issue date is consistent with the state's record, or whether the listed owner matches the registered owner. The module 170 may also assess field completeness, field confidence scores, and detect red flags such as branding remarks (e.g., “salvage”, “rebuilt”) or active liens. The validation module 170 may generate validation information such as pass/fail indicators, validation status flags, mismatch reasons, and confidence metrics, and may update the structured data object 154 to include these results as validation information. Exemplary validations performed by the validation module are described in further detail below in connection with FIG. 2A.

The execution module 180 may be responsible for performing follow-on actions based on the outcome of the validation process. The module 180 may include a determination submodule 182 for evaluating logic and conditional workflows, and a transmission submodule 185 for communicating results or triggering external transactions. For example, if the validation outcome indicates that the vehicle title is clean and the user is eligible for credit issuance, the determination submodule 182 may select a corresponding action policy. The transmission submodule 185 may then send a lien placement request to the external database system 120, including information such as VIN, lienholder identity, and user identifiers. In another example, if validation fails due to mismatched owner names or an invalid title document, the execution module 180 may transmit a structured error response to the interface module 145 for user notification, along with diagnostic metadata indicating the specific fields that failed validation. The execution module 180 thus enables the online system 140 to serve as an intelligent decision engine capable of routing outputs to appropriate downstream channels (e.g., regulatory filings, user alerts, or internal processing pipelines).

The model training engine 190 supports continuous improvement and training of the machine-learned models 152. It may receive annotated training data from manual reviewers, user feedback, or labeled validation outcomes stored in the datastore 150. In some embodiments, the training data may be organized into a multi-modal training set that includes the original document image, OCR output, and structured data templates, along with ground-truth annotations for each data field (e.g., bounding boxes and field values). The model training engine 190 may preprocess the training examples into tensors, compute loss functions (e.g., sequence-to-sequence loss, classification loss, bounding box regression loss), and perform optimization using gradient-based techniques on GPU-accelerated infrastructure. The engine 190 may also support model versioning, evaluation using validation sets, and automated retraining pipelines to periodically update deployed models based on newly acquired examples or edge-case data. The continuous feedback loop enables the online system 140 to improve its inference performance, field-level accuracy, and generalization across diverse document templates and jurisdictions.

The online system 140 may fine tune the parameters of the models 152 using training data 158. For example, the training data 158 may include examples of the data structure of an address, examples of the data structure of a VIN, and so on. Using the training data 158, the ML models 152 may be trained on data formats like VINs, addresses, names, and what structure the data formats should have. The custom models 152 can then generate structured output including an identification of the data structures they are trained to detect.

### Example Machine-Learning-Based Data Extraction and Validation Pipeline

A subset of the components of the online system 140 shown in FIG. 1B may define a machine-learning-based data extraction and validation pipeline that is configured to perform various data extraction and validation operations based on the information submitted by the user of the client device 110 as well as based on data received from the external database system 120. In one or more embodiments, the pipeline may include one or more trained machine-learned models 152, the OCR module 160, the preprocessing module 165, and the validation module 170 to extract and validate the vehicle information and the ownership information generated based on the input provided by the user. A portion of the pipeline of the online system 140 which generates a structured output (i.e., structured data objects 154) using at least the trained machine-learned models 152, the preprocessing module 165, and the validation module 170 is described in more detail based on FIG. 2A.

FIG. 2A shows that the model(s) 152 of the pipeline 210 may be configured to accept a multi-modal input (e.g., tensor generated by the preprocessing module 165) including the document images, text, and structured data templates. As shown in FIG. 2A, the input to the models 152 of the pipeline 210 may include the image(s) of the vehicle ownership information 220A (e.g., images of the front of the certificate of title or title transfer, the back of the title, the power of attorney statement, the lien certificate, affidavit, image of the physical vehicle title document, and the like) received from the client device 110. For example, the input image 220A may be a base-64 embedded image obtained by converting raw bytes of the image to a base-64 representation.

To further improve accuracy of the structured output 230 (e.g., structured data object 154), input tensor to the machine-learned model 152 of the ML-based pipeline 210 may further include as extracted text tokens 220B, e.g., the raw text generated by the OCR module 160 that can convert the document image 220A into raw text. Inputting the raw OCR text along with the image of the vehicle title document may improve accuracy of the structured output 230.

Further, the multi-modal input to the machine-learned model 152 of the ML-based pipeline 210 may include structured data templates 220C based on the desired data structure (e.g., VINs, names, addresses) that the ML-based pipeline 210 is trained to detect and validate in the input. These structured data templates 220C may be implemented as JSON structures that describe the expected characteristics, formats, and contextual cues for key data fields found on vehicle title documents. An example of a structured data template 220C is shown in FIG. 2B. As shown in the example of FIG. 2B, the structured data template 220C may define a VIN as a 17-character alphanumeric sequence matching a predetermined regular expression pattern and may describe positional or contextual indicators (e.g., label text such as “VIN” or “Vehicle Identification Number”) used to identify candidate VIN fields in the document. By providing these templates 220C as input alongside the image and OCR text, the system helps orient the model to the structure and semantics of the target fields, thereby improving accuracy, disambiguation, and robustness across document types and jurisdictions.

In some embodiments, the structured data templates 220C may include definitions for address formats (e.g., combinations of street number, name, city, state, and ZIP code) or name fields (e.g., presence of multiple capitalized words, ordering conventions, or delimiters indicating co-ownership). For example, if two names are detected with the conjunction “and” or “or,” the model may infer joint or several ownership, respectively. Similarly, signature blocks detected at the bottom of the document may be identified based on templates describing their typical layout or placement. These templates allow the ML-based pipeline 210 to generate structured ownership information that includes the names and addresses of current and prior owners, an indication of whether co-owners are present, and the inferred ownership relationship. This information may be critical for downstream decisions, such as whether additional signatures are needed to authorize lien placement.

Each structured data template 220C may act as a semantic schema that constrains the model's output space and helps align extracted tokens with expected field labels. During training, the templates may be embedded in the model's input space as part of the multi-modal training set, improving learning by encoding prior knowledge about field types and data layout. During inference, these templates 220C may serve as priors to guide extraction logic and structure the output. In some embodiments, the templates 220C may be encoded as versioned JSON schemas and dynamically updated by the system to reflect regulatory or layout changes in title documents across different issuing authorities. The use of structured data templates in the ML-based pipeline thus enables the system to normalize raw, noisy inputs into well-defined, machine-readable structured data objects 230, supporting consistent validation, decisioning, and downstream automation.

Returning to FIG. 2A, the pipeline 210 may also receive input 220 from a signature detection model for detecting the presence and location of signatures on the ownership documents (e.g., title certificate) and the name of the signatory. This information 220E may be input to the ML-based pipeline 210. The models 152 of the pipeline 210 may utilize this information for validation and include it in the structured output 230 for use by downstream sub-systems.

Any machine-learned model or combination of models 152 may be included in the ML-based pipeline 210 to generate and validate the structured output 230 based on the input 220 to the models of the pipeline 210. For example, the model 152 implemented in the ML-based pipeline 210 may include a computer vision alignment model 152 that aligns a document template to the document image input by the customer to extract structured data from the appropriate regions of the input document image and perform an alignment transform. As another example, the ML-based pipeline 210 may include a transformer-based neural network for extraction of information (vehicle information, ownership information, title information) from the image input by the user and generate a structured output 230. Such a model 152 may be trained on images of (front and/or back of) titles with types of data within different sections of the title.

In one or more embodiments, the models 152 of the pipeline 210 may further include a named entity recognition model to detect a situation where there is more than one owner listed on the ownership documents. For example, the model 152 may be an external natural language processing (NLP) service (e.g., Amazon Comprehend) to uncover valuable insights and connections in the text detected in the image and further grounded using the raw OCR text from the OCR module 160. As another example, the NLP model 152 may be a custom-built model to identify presence of co-owners on vehicle ownership documents. The custom-built model may be trained to extract the total number of individuals or entities listed on the title and whether they jointly (“and”) or severally (“or”) own the vehicle. For example, named entity recognition model may be able to determine based on the inputs whether there is more than one owner listed on the certificate of title for the vehicle, whether the owner or co-owner is a business, and whether each co-owner owns title jointly or severally. This information may be output as part of the structured output 230.

In one or more embodiments, the information 220D provided by the external database system 120 may also be input to the ML-based pipeline 210. The models 152 of the pipeline 210 may utilize this information for, e.g., validation, and include it in the structured output 230. For example, the structured output 230 from the ML-based pipeline 210 may include vehicle information such as make, model, year, color, VIN, and odometer reading. The output 230 may further include ownership information such as current and prior owner names and addresses, lien status and information, checkbox information or brand information (e.g., information indicating salvage title, junk title, odometer discrepancy indication, and the like), signature information, and the like.

The ML-based pipeline 210 may further include a validation module (e.g., module 170) to perform one or more validation checks based at least on the output from the machine-learned models 152 of the pipeline 210. The validation module (e.g., a rules engine) may further perform the validation based on information provided by the customer (e.g., in an application form), and based on information received from the external database system 120.

In one or more embodiments, the validation module of the pipeline 210 may determine whether the title provided by the customer is the most recent title. For example, a module may compare the issue date of the title uploaded by the customer with the date of the title obtained based on, e.g., the VIN or license plate number, from the external database 120. This may enable the validation module 170 to determine whether the title provided by the customer is a valid title that establishes accurate chain of title and ownership of the vehicle for lien placement.

More generally, the validation module may compare different date strings based on rules to make sure one is prior to another or within a tolerance threshold. The comparison may enable the validation module to determine based on the data received from the external database and/or the output of the signature model, whether there is any existing lien on the vehicle. For example, if the customer has signed the back of the certificate of title, this may indicate that the customer has already assigned their ownership in the vehicle to another entity. As another example, the validation module may determine there was a lien on the vehicle but that lien has been released since there is a signature date indicating a lien release date prior to the title issue date.

The validation module 170 may also validate the VIN based on one or more rules. For example, the validation module may check whether the VIN extracted from the title documents and grounded using the raw text OCR includes characters other than those that are allowed for VINs, or determine whether the VIN is the correct number of digits (e.g., not having the standard 17 digits for VINs). As another example, the validation module 170 executes a checksum included in the VIN to determine accuracy. The validation module 170 may also compare the VIN with that provided by the customer and based on the information retrieved by the external database system to determine the VIN is valid. Information generated by the validation module as a result checking for the various data points highlighted above is included as part of the structured output 230.

FIG. 2C illustrates an example structured output 230 generated by the ML-based pipeline 210 of the online system 140, based on a user-submitted title document and the processing performed by the OCR module 160, the machine-learned models 152, and the validation module 170. The structured output 230 may be encoded in a machine-readable format, such as a JSON object (key-value pairs), and may include validated fields for title information, vehicle information, and ownership information extracted from the title image. The JSON object may also include validation information generated based on the operations of the validation module 170.

In the example of FIG. 2C, the structured output includes a “vin” field that captures the vehicle identification number extracted from the document. This may be the result of a multimodal model combining image and OCR data with structured data templates to locate and identify the VIN, followed by a validation routine that confirms the format and check-digit of the VIN. The “valid_vin” flag in the validation information reflects whether this extracted VIN was determined to be valid according to the validation rules.

FIG. 2C further shows that fields such as “owner”, “co_owner”, “owner_address”, and “previous_owner” are extracted from the ownership portion of the title and included in the output. The model 152 may identify these fields based on location, linguistic cues, and expected field types from the structured data templates 220C. The structured output 230 may further include metadata fields like “lien_holder”, or “is_title_document”, indicating validation information that incorporates comparisons between the user-submitted data and external database records (e.g., data received from external system 120).

Additionally, the output of FIG. 2C may include boolean fields like “found_and” or “found_or”, which may infer whether the ownership is joint or individual based on whether the names are separated by “and” or “or” in the title document. In some embodiments, each field in the structured output 230 may be tagged with confidence scores, error types, or bounding box metadata to enable downstream exception routing or human-in-the-loop review.

This JSON output illustrated in FIG. 2C (i.e., structured output 230; structured data object 154) may be utilized for downstream workflows within the online system 140, such as determining lien eligibility, triggering regulatory reporting, or notifying the user of required corrective action. The output illustrates the results of the automated end-to-end inference and validation process of the online system 140 and may be stored in the datastore 150 (as structured data objects 154) for auditing, decision support, or reprocessing in the event of updated information from the user or from the external data sources.

In one or more embodiments, the machine-learned model 152 of the pipeline 210 may be trained by the training engine 190 using a multi-modal training set that enhances its ability to extract structured vehicle title data from heterogeneous inputs. The training set may initially include a large corpus of annotated images of physical vehicle title documents, each labeled with ground-truth values for predefined fields such as vehicle identification number (VIN), owner name, address, issuing authority, and title issue date. These annotations may be created manually or semi-automatically using human-in-the-loop labeling workflows. To convert the training set into a multi-modal dataset, the model training engine 190 may augment each annotated image with additional input modalities, including OCR text generated from the image and a corresponding structured data template representing expected field types and value formats. These structured templates help the model learn contextual field expectations, such as what a valid VIN or mailing address should look like. The model 152 is trained end-to-end using this multi-modal dataset, with a loss function that penalizes incorrect structured outputs based on a comparison between the model's predicted values and the annotated ground truth. The training process may leverage neural architectures such as transformer networks or encoder-decoder models, and may be performed on a distributed cloud infrastructure using GPUs or TPUs to accelerate convergence and handle large-scale data inputs.

The online system 140 may utilize the structured output 230 (which may include validation information) to perform different actions. For example, the different actions may include accepting the customer's application, rejecting the application, routing the application to a special sub-flow or sub-routine, and the like. Below are some non-limiting examples of the process flow of the online system 140 based on the output of the ML-based pipeline 210.

If the validation is successful, the online system 140 may allow the application process to move forward and present a credit card offer to the customer. If the customer accepts the credit card offer, the online system 140 automatically places a lien on the identified and validated vehicle, and issues the credit card to the customer. For example, the execution module 180 of the online system 140 may automatically initiate lien placement by generating and transmitting a lien registration request to the appropriate external database system 120 (e.g., a DMV system), based on the validated structured data object that includes the vehicle identification number (VIN), owner details, and lienholder information. Upon successful confirmation of lien placement, the execution module 180 may trigger an automated workflow to issue a credit card to the customer by interfacing with a credit issuance system or financial institution API, populating the application with verified customer and vehicle data, and optionally notifying the customer via the interface module 145.

If the online system 140 detects there is a co-owner that jointly owns the vehicle with the customer, the online system 140 may interact with the user interface to automatically generate a pop-up flow to prompt the customer to input the co-owners information (e.g., name, email address, phone number, relationship to customer). Based on the information provided by the customer, the online system 140 may automatically transmit a communication to the co-owner to obtain their authorization (e.g., via e-signature) to place the lien on the vehicle and issue the credit to the customer. For example, upon detecting from the structured output 230 that the vehicle has a co-owner (e.g., based on multiple owner names or an “AND” delimiter on the title document), the execution module 180 of the online system 140 may trigger the interface module 145 to display a dynamic GUI element (e.g., a modal or pop-up) prompting the customer to input contact details for the co-owner. The system 140 may then generate and transmit an authorization request to the co-owner—e.g., via email or SMS—containing a secure link to a digital consent interface where the co-owner can review the lien terms and provide authorization via an electronic signature, which is captured and stored for downstream processing.

If the online system detects during the validation check that the title uploaded by the customer using the client device 110 is not the most recent title (e.g., the issue date of the title uploaded by the customer is older than the issue date of the most recent title based on the information received from the external database 120), the online system 140 automatically rejects the application.

If the online system 140 detects that there is a mismatch or discrepancy between the VIN provided by the customer on the application form, the VIN on the title document uploaded by the customer, and the data related to the VIN pulled from the external database system 120, the online system 140 may automatically reject the application.

If the online system 140 detects that the title uploaded by the customer has been signed on the back indicating the customer has assigned their rights in the vehicle to someone else, the online system 140 may automatically reject the application.

If the online system 140 detects that the image uploaded by the customer is not a live image captured in real-time using the camera of the client device 110 (i.e., the image is a saved image in a photo library), the online system 140 automatically rejects the upload and requests the customer to reupload a real-time image of the ownership documents. The online system 140 may also include logic to detect whether the live image is real (e.g., the image is a live image of a vehicle and not an image of another image (i.e., recaptured image).

In summary, the online system 140 implementing the ML-based pipeline is configured to automatically extract information from the ownership documents provided by the customer, and automatically validate the extracted information for presence or absence of data points that would affect the ability to transfer ownership of the vehicle or transact the vehicle.

The structured output 230 including the validation information from the ML-based pipeline 210 may be used for different applications. For example, the information may be used to determine whether a valid lien can be placed on the vehicle and credit issued to the customer. As another example, the information may be used as part of a process to determine the value of the vehicle to be able to transact (e.g., purchase) the vehicle from the customer. As yet another example, the output of the pipeline 210 may be provided (e.g., via an API) to a third party who may use this information to, e.g., automate an existing workflow. For example, a used car retailer, auction, or salvage company, may outsource the data extraction and validation steps when buying used cars from customers by providing the ownership information image data and customer information to the online system 140, and receiving in real-time and automatically, the validation information and the structured data related to the vehicle information, the ownership information, and any issues identified by the online system 140 during the validation.

### Example Graphical User Interfaces

FIGS. 3A through 3M illustrate example graphical user interfaces (GUIs) generated by the interface module 145 of the online system 140 and presented on a client device 110 to guide a user through the structured vehicle title data capture and validation workflow, in accordance with one or more embodiments. These GUIs form part of a coordinated user experience implemented via a native mobile application or web-based interface, and are configured to facilitate collection of physical title document images, perform image quality control, and display status updates or error handling messages during the automated vehicle title validation pipeline described with reference to FIGS. 1B and 2.

FIGS. 3A-3I represent a user flow where the customer successfully uploads front and back images of their physical title document, the images are validated by the system, and the user is able to proceed to the next step of the credit issuance process. FIG. 3A depicts a GUI that prompts the user to upload the front of the vehicle title. The interface includes interactive controls to either launch the camera (e.g., “Take Photo”) or indicate lack of title possession (e.g., “I don't have my title”), along with instructional text generated by the interface module 145 to ensure high-quality image capture (e.g., reminders to keep the image flat and in focus). FIG. 3B shows a real-time camera capture interface in which the user photographs the front side of the physical document using the onboard camera of the client device 110. FIG. 3C presents a confirmation screen generated after image capture, allowing the user to either confirm the quality of the captured image (“Yes, looks good”) or retake the photo (“No, retake photo”). Receiving user confirmation at this stage may trigger image preprocessing routines or automated quality detection logic executed by the OCR module 160 and/or the preprocessing module 165. FIGS. 3D-3F mirror the flow of FIGS. 3A-3C but for the back of the title document.

FIG. 3G may illustrate a processing state UI, where the online system 140 (via modules 160, 165) may perform OCR, structured extraction, and validation on the submitted title images. The GUI may include animations or text indicating to the user that vehicle data is being analyzed (e.g., “Locating vehicle details”). FIG. 3H shows a successful result screen. FIG. 3H may represent a state where the vehicle information has been extracted and validated (e.g., VIN, owner name, title status), and the GUI encourages the user to proceed to the next step (e.g., issuing credit or continuing the application). This screen may also indicate that the structured output 230 has been finalized, including the validation information as described in connection with FIG. 2C.

FIG. 3I illustrates a flow for users who indicate that they do not currently have their physical title. This UI may educate the user on how to obtain a replacement title, including state-specific instructions. The system 140, through the interface module 145, may dynamically populate the replacement title process flow based on the user's registered location or entered ZIP code.

FIGS. 3J-3M illustrate various error-handling GUIs generated by the interface module 145 in response to errors detected by downstream components (e.g., validation module 170, OCR module 160). FIG. 3J displays an error screen indicating that the uploaded image (e.g., front or back) did not contain a valid title. This may occur due to document misalignment, lighting artifacts, or unsupported file types. FIG. 3K presents an image recapture prompt with enhanced instructions (e.g., “Wipe your camera lens clean”) to improve user compliance. FIG. 3L depicts a denial state triggered after an invalid image (e.g., photo of a screen or printed copy) is detected. The GUI may remind users that “pictures of pictures” are not acceptable, a policy enforced by validation heuristics or ML models trained on real-world data. FIG. 3M shows a terminal denial screen when the user has exhausted the allowed number of retries. The system 140 may disable further input to preserve system integrity, and optionally guide the user to alternative contact options or support workflows. Collectively, FIGS. 3A-3M illustrate a frontend experience architected to support high-fidelity acquisition of vehicle title data, enforce validation through backend ML and rules-based mechanisms, and support user decision-making via real-time feedback.

### Example Process

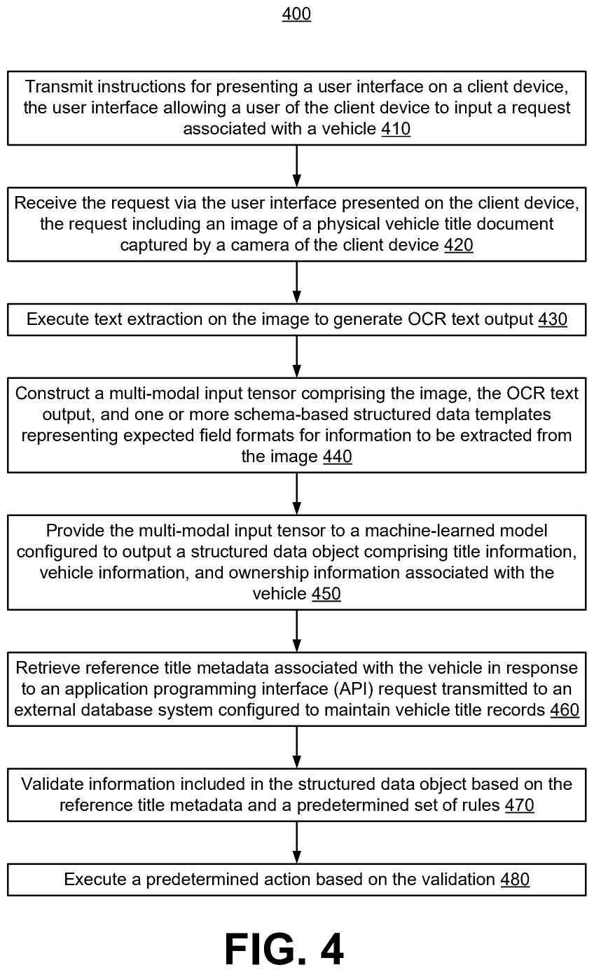

FIG. 4 is a flowchart illustrating a computer-implemented method 400 for automatically extracting and validating structured vehicle title data using an online system, in accordance with one or more embodiments. The method 400 may be performed by the online system 140 as described with reference to FIGS. 1B and 2, and may be implemented as a combination of software modules executed by one or more processors of the online system 140. In particular, the steps of method 400 may be executed by functional components such as the interface module 145, OCR module 160, preprocessing module 165, validation module 170, execution module 180, and associated data structures stored in datastore 150. Alternative embodiments may include more, fewer, or different steps from those illustrated in FIG. 4, and the steps may be performed in a different order from that illustrated in FIG. 4. Each of the steps may be performed automatically by the online system without human intervention.

At step 410, the online system 140 transmits instructions for presenting a user interface on a client device 110. The interface may be rendered via a mobile application developed and deployed by the online system 140 or via a web-based client accessible through a browser. The graphical user interface (GUI), generated by the interface module 145, may enable a user to submit a loan or credit application related to a specific vehicle by capturing and uploading an image of a physical title document. The interface may include front-end logic and user experience flows (e.g., FIGS. 3A-3F) to guide the user in capturing a high-quality image using the client device's camera.

At step 420, the online system 140 receives the request from the user, including the captured image of the physical vehicle title document. The image may be transmitted over a secure communication channel and received at a server endpoint controlled by the online system 140. The image file may be stored in association with a session identifier and/or application record in the datastore 150. Additional user-submitted information, such as vehicle identification number (VIN), license plate number, odometer reading, or applicant name/address, may also be included as part of the input request.

At step 430, the OCR module 160 of the online system 140 performs automated optical character recognition (OCR) on the submitted image to generate OCR text output. The OCR module 160 may apply a combination of image preprocessing operations (e.g., binarization, skew correction, segmentation), character recognition algorithms, and positional metadata generation to detect and extract alphanumeric content from the image. The result may be a machine-readable representation of the textual content of the title document, including word bounding boxes and layout information, which is passed forward for further processing. In some embodiments, the result may be raw OCR text.

At step 440, a preprocessing engine 165 constructs a multi-modal input tensor based on the title image, the OCR text output, and one or more schema-based structured data templates 220C. These templates, described with reference to FIGS. 2A and 2B, define expected field types, patterns, and positional structures for known data fields within a vehicle title, such as VINs, owner names, addresses, and title issue dates. The multi-modal tensor encodes the input data in a structured format suitable for machine-learned processing, such as through transformer-based neural networks or other natural language processing (NLP) models.

At step 450, the online system 140 provides the multi-modal input tensor to one or more trained machine-learned models 152. The models may include transformer-based networks, large language models, or hybrid vision-language models trained on annotated title data. In response to the input, the models may generate a structured data object 154 that includes field-level outputs corresponding to title information, vehicle information, and ownership information. These outputs may be provided as a structured JSON object containing key-value pairs, tags, and confidence scores, and may optionally be enhanced with field validation metadata as described below.

At step 460, the online system 140 may retrieve reference title metadata from an external database system 120. The reference data may be obtained via an application programming interface (API) call based on information such as the VIN or license plate number. The external database may include state DMV systems, the National Motor Vehicle Title Information System (NMVTIS), or commercial title verification platforms such as VinAudit. The reference title metadata 156 may be stored in the datastore 150 and may serve as ground truth against which the structured output 154 is validated.

At step 470, a validation module 170 may perform validation of the structured data object 154 using the reference title metadata 156 and a set of predetermined rules. These rules may include consistency checks for VIN format and length, comparison of issue dates to determine title recency, verification of owner names, identification of lienholder fields, and analysis of signature or co-ownership indicators. In some embodiments, a rules engine or LLM-based validator may execute fuzzy matching, threshold checks, or checksum validations to produce binary or probabilistic flags indicating whether specific fields are valid. The result of the validation at step 470 may be the structured validation information that is included in the structured data object 154 (FIG. 2C).

At step 480, the online system 140 may execute one or more predetermined actions based on the validation results. For example, in cases where the title is successfully validated, the system may transmit a lien placement request to the external database system 120 or initiate a credit issuance process. In other cases, the system may generate and present a notification or error message to the user, prompting corrective actions. These downstream actions may be executed by the execution module 180, which may include submodules such as a determination module 182 and transmission module 185 for deciding and carrying out the next steps in the vehicle-backed credit process. Method 400 thus provides a technically robust, scalable, and automated pipeline for extracting, validating, and processing structured vehicle title data using a combination of image processing, OCR, ML-based structured data extraction, and rule-based validation, enabling reliable, real-time credit transactions in a digital environment.

### Example Computer System

FIG. 5 is a block diagram illustrating components of an example machine for reading and executing instructions from a non-transitory machine-readable medium, in accordance with one or more example embodiments. Specifically, FIG. 5 shows a diagrammatic representation of one or more of the online system 140, the user devices 110, and the machine for performing the process 400 of FIG. 4 in the example form of a computer system 500.

The computer system 500 can be used to execute instructions 524 (e.g., program code or software) for causing the machine to perform any one or more of the methodologies (or processes) or modules described herein. In alternative embodiments, the machine operates as a standalone device or a connected (e.g., networked) device that connects to other machines. In a networked deployment, the machine may operate in the capacity of a server machine or a client machine in a client-server network environment, or as a peer machine in a peer-to-peer (or distributed) network environment.

The machine may be a server computer, a client computer, a personal computer (PC), a tablet PC, a set-top box (STB), a smartphone, an internet of things (IOT) appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes one or more processing units (generally processor 502). The processor 502 may include, for example, a central processing unit (CPU), a graphics processing unit (GPU), a digital signal processor (DSP), a control system, a state machine, one or more application-specific integrated circuits (ASICs), one or more radio-frequency integrated circuits (RFICs), or any combination of these. The computer system 500 also includes a main memory 504. The computer system 500 may further include a storage unit 516. The processor 502, memory 504, and the storage unit 516 communicate via a bus 508.

In addition, the computer system 500 may include a static memory 506, a graphics display 510 (e.g., to drive a plasma display panel (PDP), a liquid crystal display (LCD), or a projector). The computer system 500 may also include an alphanumeric input device 512 (e.g., a keyboard), a cursor control device 517 (e.g., a mouse, a trackball, a joystick, a motion sensor, or other pointing instrument), a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. For example, the instructions 524 may include the functionalities of modules of one or more of the online system 140, or user computing devices 110 of FIG. 1A, and the machine for performing the process 400 of FIG. 4. The instructions 524 may also reside, completely or at least partially, within the main memory 504 or within the processor 502 (e.g., within a processor's cache memory) during execution thereof by the computer system 500. The main memory 504 and the processor 502 also constitute machine-readable media. The instructions 524 may be transmitted or received over a network 526 via the network interface device 520.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method for extracting and validating structured vehicle title data, the method comprising:
transmitting, by an online system, instructions for presenting a user interface on a client device, the user interface allowing a user of the client device to input a request associated with a vehicle;
receiving, at the online system, the request via the user interface presented on the client device, the request including an image of a physical vehicle title document captured by a camera of the client device;
executing, by an optical character recognition (OCR) module, text extraction on the image to generate OCR text output;
constructing, by a preprocessing engine, a multi-modal input tensor comprising the image, the OCR text output, and one or more schema-based structured data templates representing expected field formats for information to be extracted from the image;
providing the multi-modal input tensor to a machine-learned model configured to output a structured data object comprising title information, vehicle information, and ownership information associated with the vehicle;
retrieving, by the online system, reference title metadata associated with the vehicle in response to an application programming interface (API) request transmitted to an external database system configured to maintain vehicle title records;
validating, by a validation module of the online system, information included in the structured data object based on the reference title metadata and a predetermined set of rules; and
executing, by the online system, a predetermined action based on the validation.

2. The computer-implemented method of claim 1, wherein executing the predetermined action comprises:
determining that the vehicle is eligible for placement of a lien on the vehicle; and
transmitting a lien registration request to the external database system, the lien registration request including at least information identifying the vehicle and a holder of the lien.

3. The computer-implemented method of claim 1, wherein executing the predetermined action comprises:
determining that the vehicle has passed the validation; and
transmitting a notification to the user interface presented on the client device, the notification indicating that the vehicle has passed the validation.

4. The computer-implemented method of claim 1, wherein executing the predetermined action comprises:
determining that the vehicle did not pass the validation; and
transmitting an error message to the user interface presented on the client device, the error message indicating a failure condition.

5. The computer-implemented method of claim 1, further comprising:
obtaining a training set including a plurality of annotated images of labeled vehicle title documents, each annotated image in the training set comprising an image and associated annotations identifying ground-truth values for predefined fields including vehicle information, title information, and ownership information;
updating the training set to be a multi-modal training set by including, for each annotated image, OCR text extracted from the annotated image, and structured data templates defining expected field types and formats; and
training the machine-learned model using the multi-modal training set to optimize a network based on a loss function that penalizes incorrect structured output.

6. The computer-implemented method of claim 1, further comprising:
generating validation information based on a result of the validation; and
updating the structured data object to include the validation information.

7. The computer-implemented method of claim 6, wherein the structured data object is encoded in a machine-readable format comprising key-value pairs corresponding to the title information, the vehicle information, the ownership information, and the validation information.

8. The computer-implemented method of claim 7, wherein the validation information comprises at least one of:
an indicator of whether the physical vehicle title document corresponding to the image is a valid vehicle title,
an indicator of whether the physical vehicle title document represents a most recent title for the vehicle,
a validity flag for a vehicle identification number (VIN) of the vehicle,
a classification of an owner of the vehicle as an individual, co-owner, or a business,
an indicator of whether an owner name extracted from the physical vehicle title document matches a registered owner identified in the reference title metadata,
a flag indicating a presence of title remarks or brand designations, or
a flag indicating whether a lien or lien release is present on the physical vehicle title document.

9. The computer-implemented method of claim 1, wherein:
the vehicle information comprises at least one of a vehicle identification number (VIN), make, model, year, odometer reading, or license plate number;
the title information comprises at least one of a document type, issuing authority, title issue date, or title control number; and
the ownership information comprises at least one of an owner name, owner address, co-owner indicator, or prior owner name.

10. A non-transitory computer-readable storage medium storing executable instructions that, when executed by a hardware processor of an online system, cause the hardware processor to perform steps comprising:
transmitting instructions for presenting a user interface on a client device, the user interface allowing a user of the client device to input a request associated with a vehicle;
receiving the request via the user interface presented on the client device, the request including an image of a physical vehicle title document captured by a camera of the client device;
executing text extraction on the image to generate OCR text output;
constructing a multi-modal input tensor comprising the image, the OCR text output, and one or more schema-based structured data templates representing expected field formats for information to be extracted from the image;
providing the multi-modal input tensor to a machine-learned model configured to output a structured data object comprising title information, vehicle information, and ownership information associated with the vehicle;
retrieving reference title metadata associated with the vehicle in response to an application programming interface (API) request transmitted to an external database system configured to maintain vehicle title records;
validating information included in the structured data object based on the reference title metadata and a predetermined set of rules; and
executing a predetermined action based on the validation.

11. The non-transitory computer-readable storage medium of claim 10, wherein the instructions that cause the hardware processor to execute the predetermined action comprise instructions that cause the hardware processor to perform steps comprising:
determining that the vehicle is eligible for placement of a lien on the vehicle; and
transmitting a lien registration request to the external database system, the lien registration request including at least information identifying the vehicle and a holder of the lien.

12. The non-transitory computer-readable storage medium of claim 10, wherein the instructions that cause the hardware processor to execute the predetermined action comprise instructions that cause the hardware processor to perform steps comprising:
determining that the vehicle has passed the validation; and
transmitting a notification to the user interface presented on the client device, the notification indicating that the vehicle has passed the validation.

13. The non-transitory computer-readable storage medium of claim 10, wherein the instructions that cause the hardware processor to execute the predetermined action comprise instructions that cause the hardware processor to perform steps comprising:
determining that the vehicle did not pass the validation; and
transmitting an error message to the user interface presented on the client device, the error message indicating a failure condition.

14. The non-transitory computer-readable storage medium of claim 10, wherein the instructions further cause the hardware processor to perform steps comprising:
obtaining a training set including a plurality of annotated images of labeled vehicle title documents, each annotated image in the training set comprising an image and associated annotations identifying ground-truth values for predefined fields including vehicle information, title information, and ownership information;
updating the training set to be a multi-modal training set by including, for each annotated image, OCR text extracted from the annotated image, and structured data templates defining expected field types and formats; and
training the machine-learned model using the multi-modal training set to optimize a network based on a loss function that penalizes incorrect structured output.

15. The non-transitory computer-readable storage medium of claim 10, wherein the instructions further cause the hardware processor to perform steps comprising:
generating validation information based on a result of the validation; and
updating the structured data object to include the validation information.

16. The non-transitory computer-readable storage medium of claim 15, wherein the structured data object is encoded in a machine-readable format comprising key-value pairs corresponding to the title information, the vehicle information, the ownership information, and the validation information.

17. The non-transitory computer-readable storage medium of claim 16, wherein the validation information comprises at least one of:
an indicator of whether the physical vehicle title document corresponding to the image is a valid vehicle title,
an indicator of whether the physical vehicle title document represents a most recent title for the vehicle,
a validity flag for a vehicle identification number (VIN) of the vehicle,
a classification of an owner of the vehicle as an individual, co-owner, or a business,
an indicator of whether an owner name extracted from the physical vehicle title document matches a registered owner identified in the reference title metadata,
a flag indicating a presence of title remarks or brand designations, or
a flag indicating whether a lien or lien release is present on the physical vehicle title document.

18. The non-transitory computer-readable storage medium of claim 10, wherein:
the vehicle information comprises at least one of a vehicle identification number (VIN), make, model, year, odometer reading, or license plate number;
the title information comprises at least one of a document type, issuing authority, title issue date, or title control number; and
the ownership information comprises at least one of an owner name, owner address, co-owner indicator, or prior owner name.

19. An online system, comprising:
a hardware processor; and
a non-transitory computer-readable storage medium storing executable instructions that, when executed by the hardware processor, cause the hardware processor to perform steps comprising:
transmitting instructions for presenting a user interface on a client device, the user interface allowing a user of the client device to input a request associated with a vehicle;
receiving the request via the user interface presented on the client device, the request including an image of a physical vehicle title document captured by a camera of the client device;
executing text extraction on the image to generate OCR text output;
constructing a multi-modal input tensor comprising the image, the OCR text output, and one or more schema-based structured data templates representing expected field formats for information to be extracted from the image;
providing the multi-modal input tensor to a machine-learned model configured to output a structured data object comprising title information, vehicle information, and ownership information associated with the vehicle;
retrieving reference title metadata associated with the vehicle in response to an application programming interface (API) request transmitted to an external database system configured to maintain vehicle title records;
validating information included in the structured data object based on the reference title metadata and a predetermined set of rules; and
executing a predetermined action based on the validation.

20. The online system of claim 19, wherein the instructions that cause the hardware processor to execute the predetermined action comprise instructions that cause the hardware processor to perform steps comprising:
determining that the vehicle is eligible for placement of a lien on the vehicle; and
transmitting a lien registration request to the external database system, the lien registration request including at least information identifying the vehicle and a holder of the lien.
